(19) United States
(12) Patent Application Publication
(10) Pub. No.: US 2023/0408831 A1
(43) Pub. Date: Dec. 21, 2023

(54) OPTICAL APPARATUS

(71) Applicant: ColorLink Japan, Ltd., Niigata (JP)

(72) Inventors: Miho NISHIYAMA, Chiba (JP); Yuta DOGEN, Kanagawa (JP)

(21) Appl. No.: 18/459,413

(22) Filed: Aug. 31, 2023

Related U.S. Application Data
(63) Continuation of application No. PCT/JP2021/008527, filed on Mar. 4, 2021.

(51) Int. Cl. G02B 27/01; G02B 27/28

(52) U.S. Cl. CPC G02B 27/0176; G02B 27/0172; G02B 27/288; G02B 2027/0154; G02B 2027/013; G02B 2027/0161

(57) ABSTRACT

An optical apparatus 100 includes: a display 110 that outputs image light 50 for forming an image; an optical system 300 that magnifies the image, the optical system having a filter 320 (a reflective polarizing plate 321) and a lens 310 (a half mirror surface 311) that are arranged on an eye point side and a display side, respectively, on an optical axis L of the display 110, each of the lens and the filter transmitting or reflecting at least a part of the image light; and a moving device 410 that moves the filter along the optical axis with respect to the lens, the moving device including a first holder 440, a second holder 420, a cover 433, thereby making it possible to adjust a position of a magnified virtual image according to a diopter of a user.

The contents of the following patent application(s) are incorporated herein by reference: NO. PCT/JP2021/008527 filed in WO on Mar. 4, 2021

### BACKGROUND

### 1. Technical Field

The present invention relates to an optical apparatus that generates a magnified virtual image of an image.

### 2. Related Art

There is known an optical apparatus adopting an immersive virtual reality (VR) technology in which an image displayed on a display panel is magnified by a thinned triple-pass optical module by folding back two optical paths by two reflection surfaces, and the magnified virtual image is projected (see, for example, Patent Document 1).
Patent Document 1: International Publication No. 2018/150773

However, an optical apparatus capable of adjusting the position of the magnified virtual image according to a diopter of a user is not known.

### GENERAL DISCLOSURE

(Item 1)

An optical apparatus may include a display that outputs image light for forming an image. The optical apparatus may include an optical system that magnifies the image, the optical system having a first transmissive/reflective surface and a second transmissive/reflective surface that are arranged on an eye point side and a display side, respectively, on an optical axis of the optical system, each of the first transmissive/reflective surface and the second transmissive/reflective surface transmitting or reflecting at least a part of the image light. The optical apparatus may include a moving device that moves the first transmissive/reflective surface along the optical axis with respect to the second transmissive/reflective surface, the moving device including a first holder that holds the display and the second transmissive/reflective surface, a second holder that holds the first transmissive/reflective surface and is supported to be able to be driven with respect to the first holder, and a cover that accommodates the first transmissive/reflective surface between the cover and the first holder. The second holder may have a hole portion and a groove portion that communicate with a space between the cover and the first transmissive/reflective surface and a space between the first transmissive/reflective surface and the second transmissive/reflective surface, and/or a gap with the cover.

(Item 2)

The cover may have a seal member that is provided between the cover and the first holder.

(Item 3)

The first transmissive/reflective surface may reflect at least a part of the image light transmitted through the second transmissive/reflective surface, and transmit at least a part of the image light reflected on the second transmissive/reflective surface.

(Item 4)

The first transmissive/reflective surface may be a polarizing element that reflects one of linearly polarized lights orthogonal to each other and transmits the other.

(Item 5)

The second transmissive/reflective surface may transmit at least a part of the image light which is sent from the display, and reflect a part of the image light which is reflected on the first transmissive/reflective surface and is returned.

(Item 6)

The second transmissive/reflective surface may be a half mirror surface.

(Item 7)

The optical system may further have a lens element. The second transmissive/reflective surface may be provided on one surface of the lens element on the display side.

(Item 8)

The second transmissive/reflective surface may be an aspherical curved surface in which a change amount of a curved surface angle continuously increases or decreases according to a distance from a center.

(Item 9)

The change amount of the curved surface angle of the second transmissive/reflective surface may continuously decrease from 1.1 degrees to 0.4 degrees from the center to an outer edge.

(Item 10)

The first holder may maintain a relative positional relationship between the display and the second transmissive/reflective surface.

(Item 11)

The moving device may further move the display along the optical axis with respect to the second transmissive/reflective surface, and the first holder may have two sub-holders that respectively hold the display and the second transmissive/reflective surface and approach each other and are separated from each other.

(Item 12)

An optical apparatus may include a display that outputs image light for forming an image. The optical apparatus may include an optical system that magnifies the image, the optical system having a first transmissive/reflective surface and a second transmissive/reflective surface that are arranged on an eye point side and a display side, respectively, on an optical axis of the optical system, the first transmissive/reflective surface transmitting or reflecting at least a part of the image light, the second transmissive/reflective surface being an aspherical curved surface in which a change amount of a curved surface angle continuously increases or decreases according to a distance from a center, and transmitting or reflecting at least a part of the image light. The optical apparatus may include a moving device that moves the first transmissive/reflective surface along the optical axis with respect to the second transmissive/reflective surface.

(Item 13)

The moving device may maintain a relative positional relationship between the display and the second transmissive/reflective surface, and moves the first transmissive/reflective surface.

(Item 14)

The first transmissive/reflective surface may be a polarizing element that reflects one of linearly polarized lights orthogonal to each other and transmits the other.

(Item 15)

The second transmissive/reflective surface may be a half mirror surface.

(Item 16)

The optical system may further have a lens element. The second transmissive/reflective surface may be provided on one surface of the lens element on the display side.

The summary clause does not necessarily describe all necessary features of the embodiments of the present invention. The present invention may also be a sub-combination of the features described above.

### BRIEF DESCRIPTION OF THE DRAWINGS

FIG. 1 schematically illustrates a configuration of an optical apparatus according to the present embodiment.

FIG. 2A illustrates an example of a surface shape of a half mirror surface (HM) of a lens.

FIG. 2B illustrates an example of a light flux cone angle characteristic after a reflection on the half mirror surface (HM) of the lens.

FIG. 3A illustrates an overall configuration of a moving device.

FIG. 3B illustrates an exploded configuration of the moving device.

FIG. 3C illustrates an assembled state of the moving device.

FIG. 4 illustrates an internal configuration of the moving device, centering on a hole portion provided in a second holder.

FIG. 5A illustrates a principle (filter unreeling) of a filter movement by the moving device.

FIG. 5B illustrates the principle (a filter movement) of the filter movement by the moving device.

FIG. 5C illustrates the principle (a filter retraction) of the filter movement by the moving device.

FIG. 6A illustrates a change in field curvature when a distance (an air distance) between a reflective polarizing plate and the half mirror surface is changed (the air distance: small).

FIG. 6B illustrates the field curvature when the distance (the air distance) between the reflective polarizing plate and the half mirror surface is changed (the air distance: intermedium).

FIG. 6C illustrates the field curvature when the distance (the air distance) between the reflective polarizing plate and the half mirror surface is changed (the air distance: large).

FIG. 7A illustrates a definition of a light beam section in the optical apparatus.

FIG. 7B illustrates a cone angle of a light beam for each light beam section illustrated in FIG. 7A.

FIG. 8 illustrates a change in field curvature with respect to the air distance for each diopter.

FIG. 9 illustrates a shift between a display surface position, and a display light emitting surface position, with respect to the air distance for each diopter.

FIG. 10A illustrates an overall configuration of the moving device according to a modification example.

FIG. 10B illustrates an exploded configuration of the moving device according to the modification example.

FIG. 10C illustrates an assembled state of the moving device according to the modification example.

FIG. 11 illustrates an internal configuration of the moving device according to the modification example, centering on a hole portion provided in a third holder.

FIG. 12A illustrates a principle (the filter unreeling) of a filter movement by the moving device according to the modification example.

FIG. 12B illustrates the principle (the filter movement) of the filter movement by the moving device according to the modification example.

FIG. 12C illustrates the principle (a filter retraction) of the filter movement by the moving device according to the modification example.

### DESCRIPTION OF EXEMPLARY EMBODIMENTS

Hereinafter, the present invention will be described through embodiments of the invention, but the following embodiments do not limit the invention according to the claims. In addition, not all combinations of features described in the embodiments are essential to the solution of the invention.

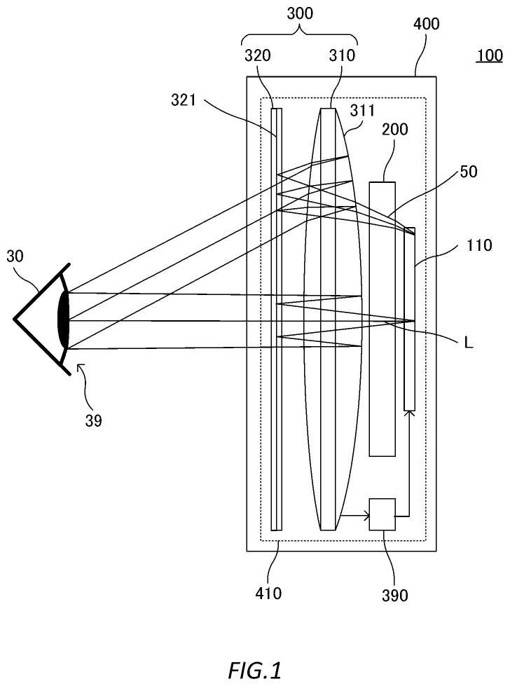

FIG. 1 schematically illustrates a configuration of an optical apparatus 100 according to the present embodiment. The optical apparatus 100 is an apparatus that generates a magnified virtual image of an image, and is used for an immersive virtual reality (VR) technology, for example. The optical apparatus 100 includes a display 110, a diffractive optical element 200, an optical system 300, a control device 390, a moving device 410, and a housing 400. Note that image light 50 which is emitted from the display 110 is guided to an eye (one eye) 30 of a user which is positioned on an eye point 39 via the diffractive optical element 200 and the optical system 300. Here, on an optical axis L of the optical system 300, a display 110 side (a right side of the drawing) is referred to as a display side, and an eye point 39 side (a left side of the drawing) is referred to as an eye point side. In addition, polarized light of the image light 50 is distinguished into linearly polarized light in a horizontal direction, linearly polarized light in a vertical direction, left-turning (also referred to as counterclockwise-turning) circularly polarized light, and a right-turning (also referred to as clockwise-turning) circularly polarized light, from a trajectory of a vibration of an electric field when the display side is viewed from the eye point side.

The display 110 is a device that displays the image. As the display 110, for example, a display device including an organic light emitting diode (OLED), a liquid crystal display device including a light source and a liquid crystal panel, or the like can be adopted. The image may be one or more images forming a still image, a moving image, or the like, or may be a color image including three colors of red, green, and blue. The display 110 outputs the image light 50 for forming the image from a display screen. In a case of the color image, each color may be emitted in a time-division manner, or may be simultaneously emitted in a manner of being superimposed on each other or being spatially divided in units of pixels.

The diffractive optical element 200 includes a plurality of elements that process the image light 50. The diffractive optical element 200 is disposed on the eye point side of the display 110 and includes a first GPH element, a first λ/4 plate, a CSF element, a second λ/4 plate, a second GPH element, a third λ/4 plate, a first polarizing plate, and a fourth λ/4 plate (none illustrated) stacked in order from the display side to the eye point side.

The first and second GPH (geometric phase hologram) elements are elements formed by distributing polymerizable liquid crystals in a specific pattern, and exert a lens action (diffusion or light condensing action) by a diffraction phenomenon while changing a polarization direction of incident light to output first-order diffracted light. The first and second GPH elements diffuse and output a light flux of the left-turning circularly polarized light, and condense and output a light flux of the right-turning circularly polarized light when unpolarized light is incident, diffuse and output a light flux while inverting the polarization direction to the left-turning circularly polarized light when the right-turning circularly polarized light is incident, and condense and output a light flux while inverting to the right-turning circularly polarized light when the left-turning circularly polarized light is incident. By using the first and second GPH elements, it is possible to compensate for a wavelength dispersion of a refraction angle with respect to the image light 50 and a chromatic aberration associated therewith.

The first to fourth λ/4 plates are elements that give a phase difference of ¼ wavelength to two polarized components of the image light 50 and modulate the two polarized components. The λ/4 plate modulates a linearly polarized light into a circularly polarized light and a circularly polarized light into a linearly polarized light.

A wavelength-selective polarization conversion (CSF) element is an element that rotates the polarization direction by 90 degrees only in a specific wavelength region. For example, the CSF element modulates a linearly polarized light in the vertical direction to a linearly polarized light in the horizontal direction, and a linearly polarized light in the horizontal direction to a linearly polarized light in the vertical direction.

The first polarizing plate is an element (so-called linearly polarizing plate) that absorbs one of the linearly polarized lights orthogonal to each other and transmits the other. As an example, the first polarizing plate transmits the linearly polarized light in the vertical direction and absorbs the linearly polarized light in the horizontal direction.

Note that the configuration of the diffractive optical element 200 described above is an example, and may include the polarizing plate and the λ/4 plate stacked in order from the display side to the eye point side, or the GPH element, the λ/4 plate, the polarizing plate, and the λ/4 plate stacked in order from the display side to the eye point side.

The optical system 300 is a triple-pass type optical system which is thinned by folding back an optical path twice by two reflection surfaces, and includes a filter 320 and a lens 310 arranged on the eye point side and the display side on the optical axis L, respectively. The optical system 300 diffuses the image light 50 by the lens 310 to magnify the image.

The filter 320 includes a plurality of elements that process the image light 50. The filter 320 is disposed on the eye point side of the lens 310 and for example, includes a fifth λ/4 plate (not illustrated), a reflective polarizing plate 321, and a second polarizing plate (not illustrated) stacked in order from the display side to the eye point side.

The fifth λ/4 plate is an element that modulates the image light 50 via the lens 310 by giving a phase difference of ¼ wavelength to the two polarized components.

The reflective polarizing plate 321 is an example of a first transmissive/reflective surface that transmits or reflects at least a part of the image light 50, and is a polarizing element that reflects one linearly polarized light of the linearly polarized lights orthogonal to each other and transmits the other linearly polarized light. As an example, the reflective polarizing plate 321 transmits the linearly polarized light in the vertical direction and reflects the linearly polarized light in the horizontal direction.

The second polarizing plate is an element that absorbs one of the linearly polarized lights orthogonal to each other and transmits the other. As an example, the second polarizing plate transmits the linearly polarized light in the vertical direction and absorbs the linearly polarized light in the horizontal direction.

The lens 310 is an element that diffuses the image light 50 to magnify the image. The LENS 310 may be a single biconvex lens, and is designed to have a diopter (diopter, inverse of a focal length value in units of meters) of any value, for example, in a range from −5 to +2. The lens 310 has a half mirror surface 311, which is an example of a second transmissive/reflective surface that transmits or reflects at least a part of the image light 50, on one surface of the lens 310 on the display side. The half mirror surface 311 is a curved surface, in particular, an aspherical surface in which a change amount of a curved surface angle continuously increases or decreases according to a distance from the center.

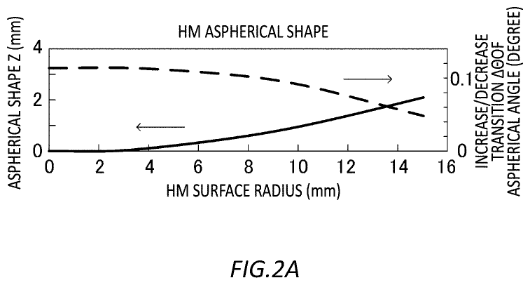

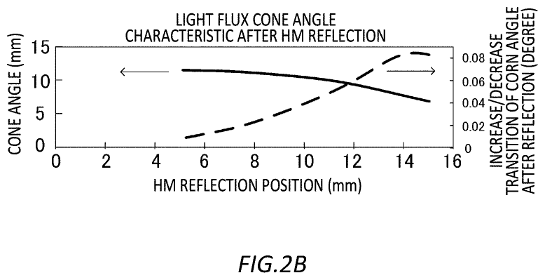

FIG. 2A illustrates an example of a surface shape of a half mirror surface (HM) 311 of a lens 310. Here, the solid line indicates an aspherical shape of the half mirror surface (HM) 311 by a surface position Z with respect to a surface radius. The broken line indicates a change amount AO of the curved surface angle of the half mirror surface (HM) 311 with respect to the surface radius. In the surface shape of the half mirror surface 311, the surface position Z is shifted with the increasing distance from the center to the outside; however, the change amount AO of the curved surface angle tends to decrease with the increasing distance from the center to the outside, and continuously decreases from 1.1 degrees to 0.4 degrees from the center to an outer edge, as an example.

FIG. 2B illustrates an example of a light flux cone angle characteristic after a reflection on the half mirror surface (HM) 311 of the lens 310. Here, the solid line indicates the light flux cone angle after the reflection on the half mirror surface (HM) 311 with respect to a reflection position. However, a width of the light flux before the reflection has been set to 5 mm, and the cone angle has been set to an infinite distance condition (parallel). The broken line indicates a transition of the change amount of the light flux cone angle after the reflection on the half mirror surface (HM) 311 with respect to the reflection position. The light flux cone angle decreases as it goes away from the center of the half mirror surface 311 toward the outside, and the change amount tends to increase.

Since the change amount AO of the curved surface angle of the half mirror surface 311 tends to decrease as it goes away from the center toward the outside, the change amount of the light flux cone angle after the reflection on the half mirror surface 311 tends to increase as it goes away from the center toward the outside. As a result, the field curvature can be corrected by moving the half mirror surface 311 in the optical axis direction and changing the reflection position of the image light 50 on the half mirror surface 311 in a surface radial direction.

Note that, instead of the lens 310, a lens element that exerts a lens action on the image light 50 by combining optical elements including a plurality of lenses, for example, a biconvex lens and a concave meniscus lens, may be adopted.

The control device 390 is a device that controls each component of the optical apparatus 100. The control device 390 may drive the filter 320 in a direction of the optical axis L by rotating a cover holder 430 of the moving device 410 to be described below by, for example, a rotary motor, an actuator, or the like (not illustrated) included in the housing 400.

In addition, the control device 390 changes a distortion correction value of the image according to a state of the optical system 300, for example, the diopter of the optical system 300. For example, in the triple-pass optical system 300, a virtual image tends to be distorted in a pincushion shape. Therefore, the control device 390 corrects a distortion by causing the display 110 to display a barrel-shaped distortion image by an amount that cancels the pincushion-shaped distortion by the optical system 300. Here, the distortion of the optical system 300 is measured in advance by using a camera or the like, and a distortion amount for generating a barrel-shaped distortion image that cancels the distortion is stored in the control device 390 as a distortion correction value. When a degree of distortion by the optical system 300 is different for each diopter, the distortion is measured for each diopter, and the distortion correction value is stored in the control device 390. The control device 390 inputs the distortion correction value according to the diopter of the optical system 300 to the display 110, and causes the display 110 to display the barrel-shaped distortion image according to the distortion correction value, thereby correcting the distortion of the diopter selected by the user.

The moving device 410 is a device that moves the filter 320 (especially the reflective polarizing plate 321) along the optical axis L with respect to the lens 310 (especially the half mirror surface 311). A position of the magnified virtual image can be changed by moving the filter 320 with respect to the lens 310 to change a folded length of the optical path of the image light 50 therebetween by the moving device 410. The details of the configuration of the moving device 410 will be described below.

The housing 400 accommodates the display 110, the diffractive optical element 200, the optical system 300, and the moving device 410.

The principle in which the optical apparatus 100 guides the image light 50 of the display 110 to the eye 30 of the user will be described.

The display 110 generates and outputs the unpolarized image light 50. By making the image light 50 unpolarized, luminance unevenness can be prevented when the image light 50 passes through the first GPH element for correcting the chromatic aberration.

The image light 50 output from the display 110 is incident on the diffractive optical element 200. In the diffractive optical element 200, the image light 50 first enters the first GPH element. As a result, one of the ±first-order diffracted lights of the unpolarized image light 50 is diffused and output as the left-turning circularly polarized light, and the other is condensed and output as the right-turning circularly polarized light. Next, the image light 50 enters the first λ/4 plate. As a result, the image light 50 of the left-turning circularly polarized light is modulated into a linearly polarized light in the horizontal direction, and the image light 50 of the right-turning circularly polarized light is modulated into a linearly polarized light in the vertical direction. Next, the image light 50 enters the CSF. As a result, the image light 50 of the linearly polarized light in the horizontal direction in the specific wavelength region is modulated into the linearly polarized light in the vertical direction, and is output together with the image light 50 of the linearly polarized light in the vertical direction outside the specific wavelength region. The image light 50 of the linearly polarized light in the vertical direction in the specific wavelength region is modulated into the linearly polarized light in the horizontal direction, and then removed by the first polarizing plate. As a result, one of the diffused light and the focused light output from the first GPH element is output from the diffractive optical element 200 according to the wavelength region, that is, the optical path is changed according to the wavelength region, whereby the chromatic aberration is corrected. Hereinafter, only the image light 50 of the linearly polarized light in the vertical direction output from the CSF will be described.

Next, the image light 50 enters the second λ/4 plate. As a result, the image light 50 of the linearly polarized light in the vertical direction is modulated into the left-turning circularly polarized light. Next, the image light 50 enters the second GPH element. As a result, the image light 50 of the left-turning circularly polarized light is modulated into the right-turning circularly polarized light while receiving the light condensing action. Next, the image light 50 enters the third λ/4 plate. As a result, the image light 50 of the right-turning circularly polarized light is modulated into the linearly polarized light in the vertical direction. Next, the image light 50 enters the first polarizing plate. The image light 50 of the linearly polarized light in the vertical direction is transmitted through the first polarizing plate, and unnecessary light of the linearly polarized light in the horizontal direction is absorbed by the first polarizing plate. Next, the image light 50 enters the fourth λ/4 plate. As a result, the image light 50 of the linearly polarized light in the vertical direction is modulated into the left-turning circularly polarized light. In this way, the image light 50 is modulated into the left-turning circularly polarized light and the chromatic aberration is compensated, and the image light 50 is output from the diffractive optical element 200 to the eye point side.

Note that, in the optical apparatus 100 according to the present embodiment, the image light 50 modulated into the linearly polarized light in the vertical direction by the first λ/4 plate and the CSF element in the diffractive optical element 200 is used, and the image light 50 modulated into the linearly polarized light in the horizontal direction is removed by the first polarizing plate as unnecessary light: however, instead of this, the image light 50 modulated into the linearly polarized light in the horizontal direction by the first λ/4 plate and the CSF element in the diffractive optical element 200 may be used, and the image light 50 modulated into the linearly polarized light in the vertical direction may be removed by the first polarizing plate as unnecessary light.

The image light 50 output from the diffractive optical element 200 enters the optical system 300. In the optical system 300, the image light 50 is first incident on the lens 310. As a result, the image light 50 having a half intensity is transmitted through the half mirror surface 311 without depending on a polarization state, and is magnified by the lens action to be output to the eye point side, and the image light 50 having the remaining half intensity is reflected on the half mirror surface 311.

Next, the image light 50 is incident on the filter 320. Within the filter 320, the image light 50 first enters the fifth λ/4 plate. As a result, the image light 50 of the left-turning circularly polarized light is modulated into the linearly polarized light in the horizontal direction. Next, the image light 50 enters the reflective polarizing plate. As a result, the image light 50 of the linearly polarized light in the horizontal direction is reflected. The image light 50 enters the fifth λ/4 plate again. As a result, the image light 50 of the linearly polarized light in the horizontal direction is modulated into the right-turning circularly polarized light. In this way, the image light 50 is reflected on the filter 320 and output to the display side.

The image light 50 is incident on the lens 310 from the eye point side. As a result, for the image light 50, the image light 50 having a half intensity is magnified by the lens action, and is reflected on the half mirror surface 311 to be output to the eye point side, and the image light 50 having the remaining half intensity is transmitted through the half mirror surface 311.

The image light 50 is incident on the filter 320 again. Within the filter 320, the image light 50 first enters the fifth λ/4 plate. As a result, the image light 50 of the right-turning circularly polarized light is modulated into the linearly polarized light in the vertical direction. Next, the image light 50 enters the reflective polarizing plate. The image light 50 of the linearly polarized light in the vertical direction is transmitted through the reflective polarizing plate. Next, the image light 50 enters the second polarizing plate. The image light 50 of the linearly polarized light in the vertical direction is transmitted through the second polarizing plate, and unnecessary light of the linearly polarized light in the horizontal direction is absorbed by the second polarizing plate. The diffused image light 50 is output from the filter 320 to the eye point side.

In this way, the image light 50 once passes through the lens 310 in the optical system 300, is reflected by the filter 320 and reciprocates through the lens 310, is further subjected to the lens action by the lens 310 to be magnified, is output to the eye point side, and is guided to the eye 30 of the user.

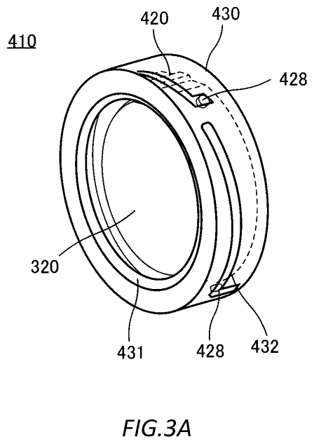

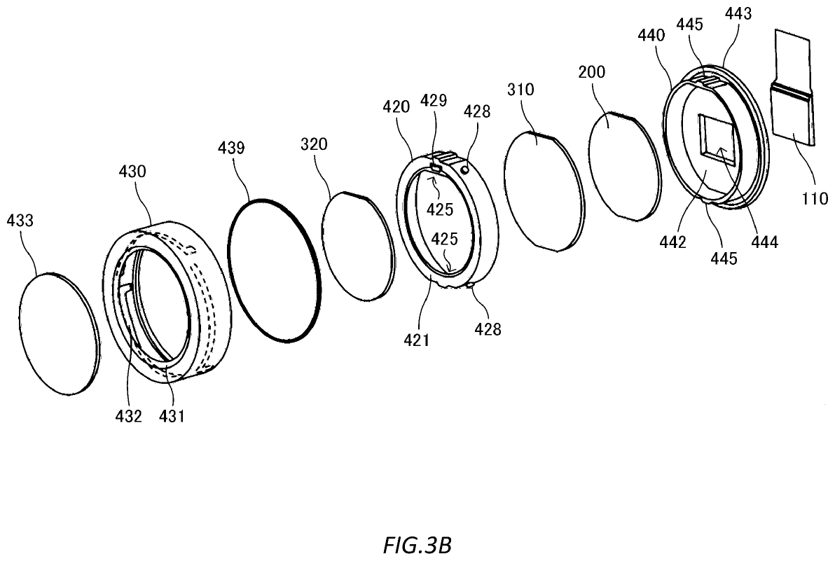

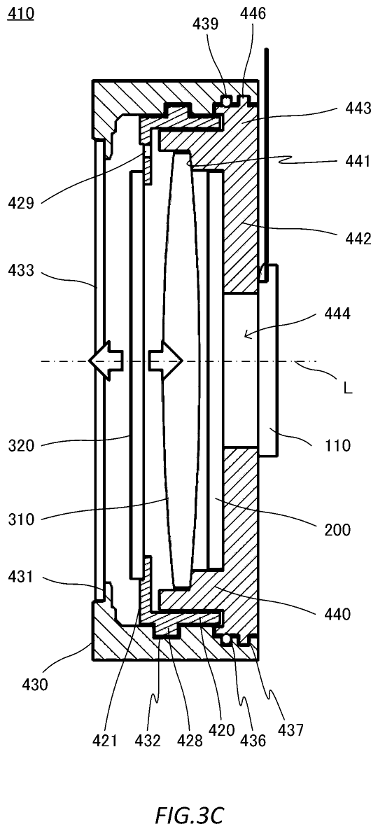

FIG. 3A, FIG. 3B, and FIG. 3C illustrate an overall configuration, an exploded configuration, and an assembled state of the moving device 410, respectively. The moving device 410 includes a first holder 440, a second holder 420, a cover holder 430, and a seal ring 439. Note that the right side of the drawing is the display side, and the left side of the drawing is the eye point side. In addition, the central axis of the moving device 410 overlaps the optical axis L of the optical system 300.

The first holder 440 is a fixing member that holds the display 110, the diffractive optical element 200, and the lens 310 of the optical system 300. The first holder 440 is formed in a cylindrical shape having a bottom surface 442, and has a step portion 441 on the eye point side of an inner surface; a flange portion 443 formed to protrude outward at an end portion of an outer surface on the display side; a protruding portion 446 formed around an outer surface of the flange 443; a rectangular opening 444 formed in the center of the bottom surface 442; and two guides 445 formed to extend parallel to the optical axis L on the outer surface. Note that the number of guides 445 is not limited to two, and one or three or more may be formed.

The display 110 is fixed on an end surface of the first holder 440 on the display side such that the display screen of the display 110 is positioned within the opening 444. The diffractive optical element 200 is fixed within the first holder 440 to be supported on the bottom surface 442. The lens 310 is fixed to an end portion of the first holder 440 on the eye point side such that an edge portion of the lens 310 is supported on the step portion 441. In this way, the display 110, the diffractive optical element 200, and the lens 310 maintain their relative positional relationship in relation to the direction of the optical axis L, and are held by the first holder 440.

The second holder 420 is a movable member that holds the filter 320 of the optical system 300 and is supported to be able to be driven with respect to the first holder 440. The second holder 420 is formed in a cylindrical shape having an inner diameter slightly larger than an outer diameter of the first holder 440, and has a support surface 421 formed to protrude inward from the eye point side of the inner surface. The filter 320 is supported by the support surface 421, and a center portion of the filter 320 is positioned within an opening of the second holder 420 on the eye point side. Further, the second holder 420 has three cam pins 428 formed on the outer surface to be separated from each other in a peripheral direction; a guide groove 425 formed to extend parallel to the optical axis L on the inner surface; and a hole portion 429 formed to connect an inside and an outside of the second holder 420 in the support surface 421.

The cover holder 430 is a movable member that holds a cover 433 and is rotated with respect to the first holder 440. The cover holder 430 is formed in a cylindrical shape having an inner diameter slightly larger than an outer diameter of the second holder 420, and has a step portion 431 formed for a protruding portion to protrude inward on the eye point side of the inner surface. The cover 433 that is translucent is fitted into the cover holder 430 from an opening on the eye point side, and is supported on the step portion 431. Further, the cover holder 430 has three cam grooves 432 formed to extend in the direction of the optical axis L direction from the end portion on the display side, to spirally extend by changing directions, and to be separated from each other in the peripheral direction on the inner surface. In addition, the cover holder 430 has two grooves 436 and 437 formed around the display side of the inner surface.

The seal ring 439 is a member formed of an elastic member such as rubber in a ring shape. The seal ring 439 is fitted into the groove 436 of the cover holder 430 to seal an inside of the moving device 410.

The moving device 410 is assembled as follows. First, while the guide 445 of the first holder 440 on the outer surface is put into the guide groove 425 of the second holder 420 on the inner surface, the end portion of the first holder 440 holding the lens 310 on the eye point side is inserted from the opening of the second holder 420 on the display side, into the inside thereof. Next, the seal ring 439 is fitted into the groove 436 of the cover holder 430. Then, the three cam pins 428 of the second holder 420 on the outer surface are respectively inserted into the three cam grooves 432 of the cover holder 430 on the inner surface; an end portion of the second holder 420 on the eye point side holding the filter 320 is inserted from the opening of the cover holder 430 on the display side, into the inside thereof; and further the protruding portion 446 of the first holder 440 is fitted into the groove 437 of the cover holder. As a result, the cover holder 430 is supported to be rotated with respect to the first holder 440, and in an internal space of the moving device 410 which is defined by the cover holder 430 holding the cover 433 and the first holder 440 holding the lens 310 or the like, the second holder 420 holding the filter 320 is accommodated to be able to be driven in the direction of the optical axis L (see the arrow in FIG. 3C).

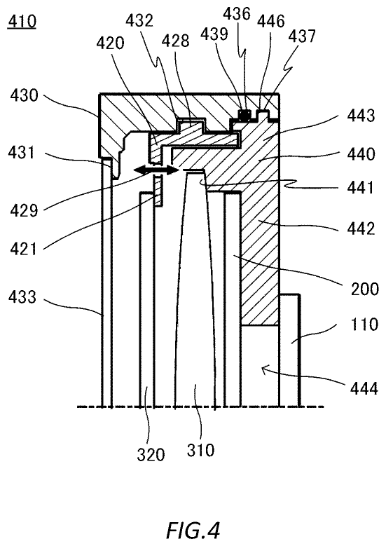

FIG. 4 illustrates an internal configuration of the moving device 410, centering on the hole portion 429 provided in the second holder 420. The seal ring 439 is interposed between an inner surface of the cover holder 430 and an outer surface of the first holder 440, thereby sealing the internal space of the moving device 410. A space between the cover 433 and the filter 320 and a space between the filter 320 and the lens 310 are connected to each other by the hole portion 429 formed in the second holder 420, and as the filter 320 moves, an air moves from one space to the other space (see the arrow).

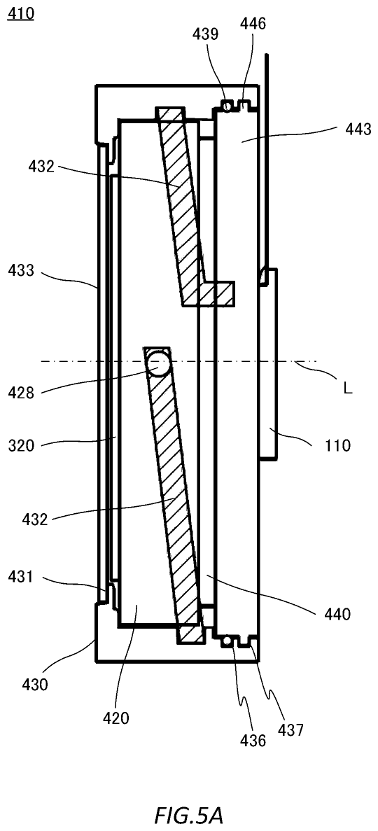

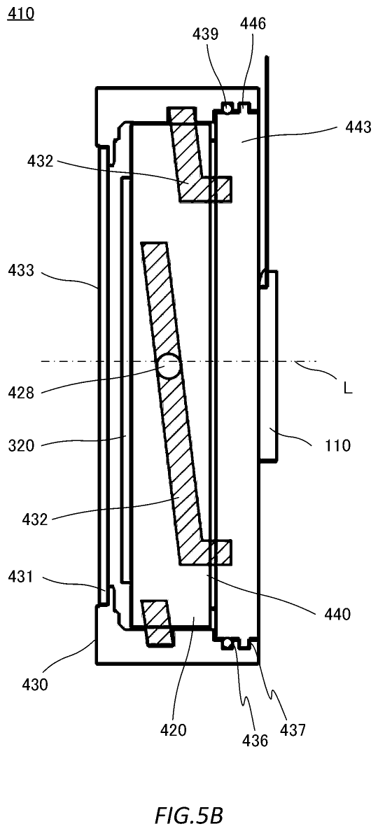

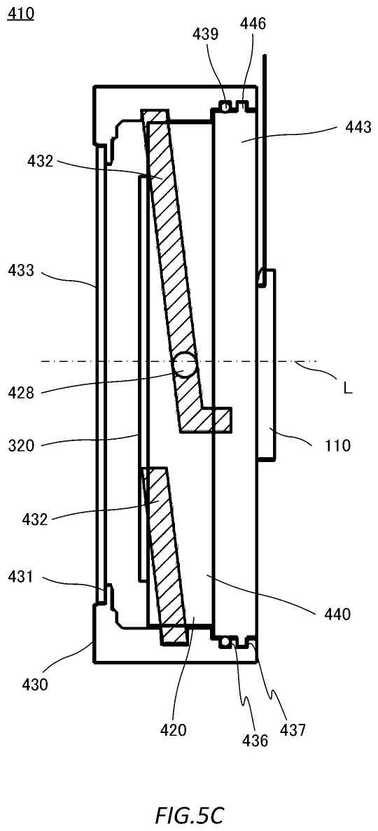

FIG. 5A, FIG. 5B, and FIG. 5C illustrate the principles of filter movements by the moving device 410. In the moving device 410 configured as described above, when the cover holder 430 is rotated with respect to the first holder 440, the cam pin 428 formed on an outer surface of the second holder 420 is guided inside the cam groove 432 provided on the inner surface of the cover holder 430 and the guide 445 of the first holder 440 is guided inside the guide groove 425 of the second holder, whereby the second holder 420 is driven between the cover holder 430 and the first holder 440 in the direction of the optical axis L.

As illustrated in FIG. 5A, when the cover holder 430 is rotated clockwise when viewed from the eye point side to the display side, the cam pin 428 formed on the outer surface of the second holder 420 is guided inside the cam groove 432 provided on the inner surface of the cover holder 430 and the guide 445 of the first holder 440 is guided inside the guide groove 425 of the second holder, and the second holder 420 holding the filter 320 is unreeled to the eye point side. As a result, the filter 320 is separated from the lens 310 and the display 110. At this time, an internal air moves, via the hole portion 429 of the second holder 420, from the space between the cover 433 and the filter 320 to the space between the filter 320 and the lens 310 (see the rightward arrow in FIG. 4).

As illustrated in FIG. 5B and FIG. 5C, when the cover holder 430 is rotated counterclockwise, the cam pin 428 formed on the outer surface of the second holder 420 is guided inside the cam groove 432 provided on the inner surface of the cover holder 430 and the guide 445 of the first holder 440 is guided inside the guide groove 425 of the second holder, and the second holder 420 is retracted to the display side. As a result, the filter 320 approaches the lens 310 and the display 110. At this time, the internal air moves, via the hole portion 429 of the second holder 420, from the space between the filter 320 and the lens 310 to the space between the cover 433 and the filter 320 (see the leftward arrow in FIG. 4). Accordingly, the sealing of the inside of the moving device 410 is maintained, and it is possible to prevent a foreign matter such as dust from infiltrating from the outside.

In this way, the moving device 410 maintains the relative positional relationship between the display 110, the diffractive optical element 200, and the lens 310 (the half mirror surface 311), and relatively moves the filter 320 (the reflective polarizing plate 321) with respect to them. By the cover 433 and the cover holder 430 holding the cover 433; the display 110, the diffractive optical element 200, the lens 310, and the first holder 440 holding them; and the seal ring 439 that is provided between the cover holder 430 and the first holder 440, the inside of the moving device 410 is kept to be airtight, and the internal air moves, via the hole portion 429 of the second holder 420, between the space between the cover 433 and the filter 320 and the space between the filter 320 and the lens 310, thereby making it possible to drive the filter 320 in the space in an airtight state.

Note that as long as it is possible to move the internal air between the space between the cover 433 and the filter 320 and the space between the filter 320 and the lens 310, the hole portion 429 may be formed on a side surface of the second holder 420 without being limited to the support surface 421. At this time, a groove portion extending from the hole portion 429 to the end portion of the second holder 420 on the eye point side may be formed on the outer surface of the second holder 420. In addition, the hole portion may be formed in an edge portion of the filter 320. In addition, between the cover holder 430 and the second holder 420, and further between the second holder 420 and the first holder 440, a gap in which the air can move may be provided.

In the optical apparatus 100, it is necessary to keep the field curvature of the virtual image displayed at a virtual image position within a focal depth of the optical system 300. However, in the case of the triple-pass optical system 300, since the focal depth is shallow, there is a problem that the field curvature does not fall within the focal depth as the diopter of the optical system 300 is changed. Therefore, in the optical apparatus 100 according to the present embodiment, the filter 320 (the reflective polarizing plate 321) is moved along the optical axis L with respect to the lens 310 (the half mirror surface 311) by the moving device 410, and the distance between the reflective polarizing plate 321 and the half mirror surface 311 is changed, thereby making it possible to adjust the field curvature and keep the field curvature within the focal depth for each diopter.

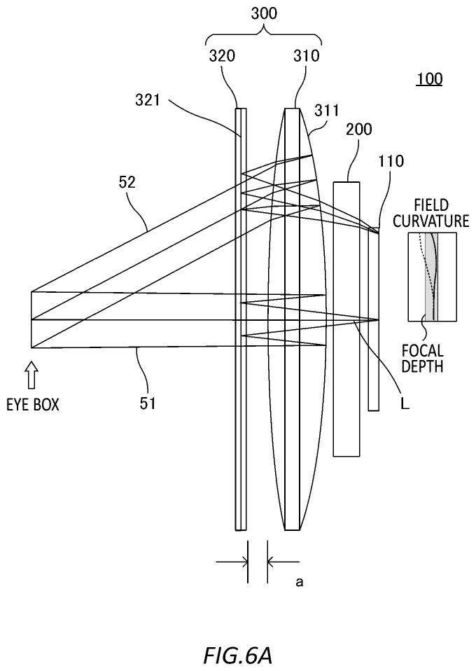

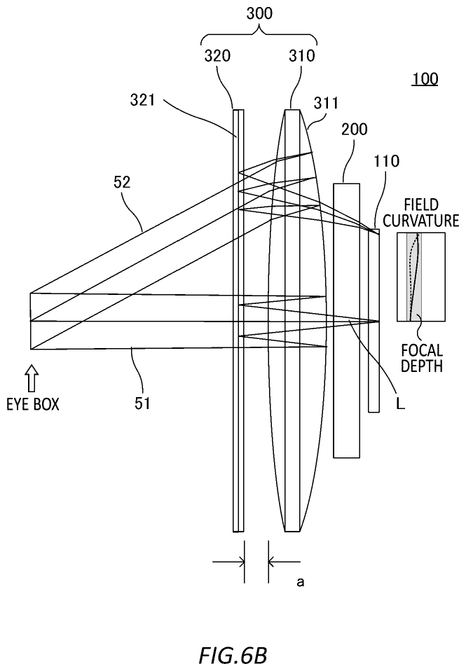

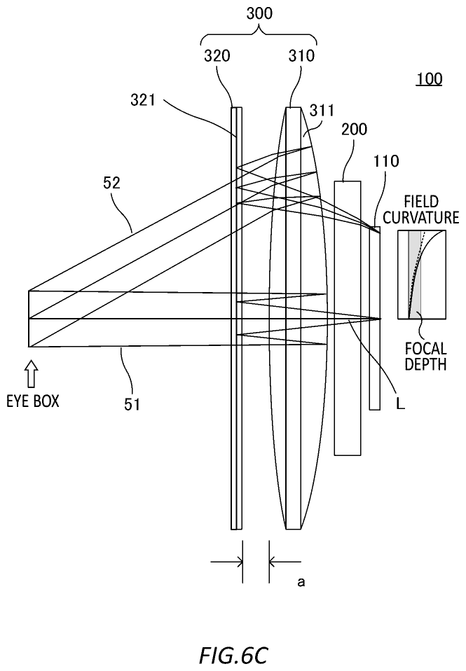

FIG. 6A to FIG. 6C illustrate changes in a trajectory of a light beam and the field curvature in a case where the diopter of the optical system 300 is uniquely set, and a distance a (referred to as a spatial distance or an air distance) between the reflective polarizing plate 321 and the half mirror surface 311 is changed by moving the filter 320 (the reflective polarizing plate 321) along the optical axis L with respect to the lens 310 (the half mirror surface 311). However, in a light beam reverse tracking simulation, a light beam is drawn from the virtual image position toward an eye box, and retroreflected on the eye box to follow the trajectory of the light beam toward the display 110, and the curvature of the image plane imaged on the display is analyzed. Note that, in the present example, the diopter of the optical system 300 is set to −3. Each drawing illustrates a light beam (referred to as center light 51) which is horizontally reflected from the eye box to the display side to reach the center of the display screen of the display 110, and a light beam (referred to as ambient light 52) which is reflected obliquely upward from the eye box to the display side to reach an upper end of the display 110.

FIG. 6A illustrates the trajectory of the light beam and the field curvature on the display screen of the display 110 in a case of the air distance a=1.65 mm. Note that the field curvature is indicated at a position in the direction of the optical axis L where the light beam is most focused. Here, the solid line indicates the field curvature on the tangential plane, and the broken line indicates the field curvature on the sagittal plane. The hatched region represents a range of a focal diopter of the optical system 300, and the field curvature needs to fall within this range. The center light 51 horizontally reflected from the eye box to the display side is transmitted through the filter 320, enters the lens 310, is reflected at the center of the half mirror surface 311, is condensed and transmitted to the eye point side, is reflected on the reflective polarizing plate 321 in the filter 320, is transmitted through the lens 310, is further condensed, and reaches the center of the display 110 via the diffractive optical element 200. The ambient light 52 reflected obliquely upward from the eye box to the display side is transmitted through the filter 320, enters the lens 310, is reflected on an upper side of the half mirror surface 311, is condensed and transmitted obliquely downward to the eye point side, is reflected on the reflective polarizing plate 321 in the filter 320, is transmitted through the lens 310, is further condensed, and reaches the upper end of the display 110 via the diffractive optical element 200. The image plane tends to be imaged on the eye point side in the periphery with respect to the center of the display 110, and is somewhat beyond the range of the focal depth.

FIG. 6B illustrates the trajectory of the light beam and the field curvature on the display screen of the display 110 in a case of the air distance a=1.75 mm. The center light 51 horizontally reflected from the eye box to the display side is condensed similarly to the case of the air distance a=1.65 mm, and reaches the center of the display 110 following the same optical path. The ambient light 52 reflected obliquely upward from the eye box to the display side is transmitted through the filter 320, enters the lens 310, is reflected further on the upper side of the half mirror surface 311, is condensed and transmitted obliquely downward to the eye point side, is reflected on the reflective polarizing plate 321 in the filter 320, is transmitted through the lens 310, is further condensed, and reaches an upper side of the display 110 via the diffractive optical element 200. The field curvature is small and is within the focal depth.

FIG. 6C illustrates the trajectory of the light beam and the field curvature on the display screen of the display 110 in a case of the air distance a=1.95 mm. The center light 51 horizontally reflected from the eye box to the display side is condensed similarly to the case of the air distance a=1.65 mm, and reaches the center of the display 110 following the same optical path. The ambient light 52 reflected obliquely upward from the eye box to the display side is transmitted through the filter 320, enters the lens 310, is reflected further on the upper side of the half mirror surface 311, is condensed and transmitted obliquely downward to the eye point side, is reflected on the reflective polarizing plate 321 in the filter 320, is transmitted through the lens 310, is further condensed, and reaches the upper side of the display 110 via the diffractive optical element 200. The image plane tends to be imaged on the display side in the periphery with respect to the center of the display 110, and is somewhat beyond the range of the focal depth.

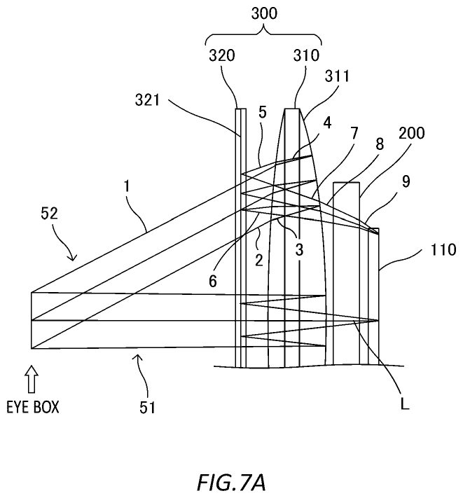

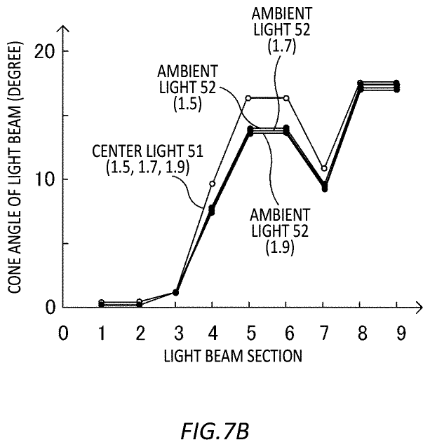

FIG. 7A illustrates a definition of a light beam section in the optical apparatus 100. Here, a light beam section 1 represents a section from the eye box to an emission surface of the filter 320, a light beam section 2 represents a section from an incident surface of the filter 320 to the emission surface of the lens 310, a light beam section 3 represents a section from the emission surface of the lens 310 to the incident surface (the half mirror surface 311) of the lens 310, a light beam section 4 represents a section from the incident surface (the half mirror surface 311) of the lens 310 to the emission surface of the lens 310, a light beam section 5 represents a section from the emission surface of the lens 310 to the incident surface of the filter 320, a light beam section 6 represents a section from the incident surface of the filter 320 to the emission surface of the lens 310, a light beam section 7 represents a section from the emission surface of the lens 310 to the incident surface of the lens 310, a light beam section 8 represents a section from the incident surface of the lens 310 to the emission surface of the diffractive optical element 200, and a light beam section 9 represents a section from the incident surface of the diffractive optical element 200 to the emission surface of the display 110. Note that the light beam sections are defined for the ambient light 52 in FIG. 7A, but are also defined for the center light 51 in a similar manner.

FIG. 7B illustrates cone angles of the center light 51 and the ambient light 52 for each of the light beam sections 1 to 9 in the optical apparatus 100 defined in FIG. 7A. The cone angle of the center light 51 is equal for each of the air distances a=1.65, 1.75, and 1.95 mm, is zero in the light beam sections 1 and 2, increases in the sections 3 and 4, that is, is expanded by entering the lens 310, becomes constant in the sections 5 and 6, decreases in the section 7, increases again in the section 8, and reaches the display 110 at the maximum angle in the section 9. A behavior of the cone angle of the ambient light 52 is the same as that of the cone angle of the center light 51. However, the cone angle of the ambient light 52 varies depending on the air distance after the section 4 in which the ambient light 52 enters the lens 310. That is, as the air distance increases, the ambient light 52 enters the upper side of the half mirror surface 311, so that the cone angle decreases, and the ambient light 52 is condensed far. As the air distance decreases, the ambient light 52 enters a lower side of the half mirror surface 311, so that the cone angle increases, and the ambient light 52 is condensed near.

By changing the air distance, a light flux condensed position around the screen can be changed back and forth with respect to a light flux condensed position at the screen center, thereby making it possible to adjust the field curvature. Note that, as illustrated in FIG. 2B, the change amount of the cone angle increases toward the periphery of the half mirror surface 311, so that the field curvature can be corrected by changing the air distance.

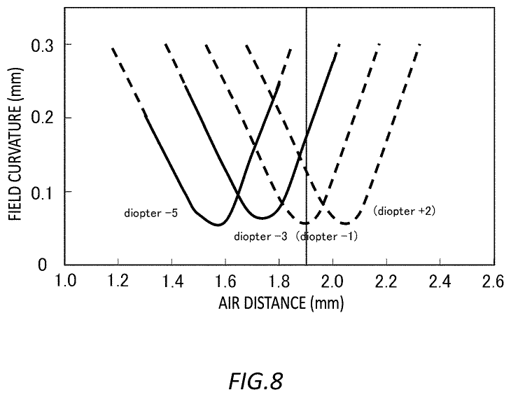

FIG. 8 illustrates a change in field curvature with respect to the air distance for each of diopters −5, −3, −1, and +2. The field curvature decreases as the air distance increases, exhibiting a minimum at some air distance, and exhibits the behavior of increasing as the air distance further increases. For each diopter, there is an air distance at which the field curvature is minimized. Therefore, it can be seen that the field curvature can be minimized more precisely according to the diopter, by roughly selecting the diopter according to the diopter of the user, designing the optical system 300, and moving the optical system 300 with respect to the filter 320.

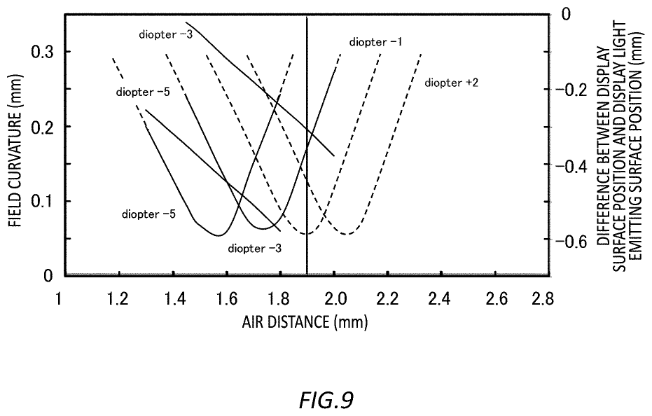

FIG. 9 illustrates a shift (the solid line) between a display surface position, and a display light emitting surface position, with respect to the air distance for each of diopters −5 and −3, to be superimposed on the field curvature (the broken line) described above. In the light beam reverse tracking simulation, the light beam is drawn from the virtual image position toward the eye box, and retroreflected on the eye box to follow the trajectory of the light beam toward the display 110, thereby calculating the display surface position (that is, display center portion). The display light emitting surface position is a position of the display screen (that is, a light emitting surface) of the display 110, and in the present example, at the air distance (1.9 mm in the present embodiment) at which the field curvature is minimized with respect to diopter −1, the display surface position was selected when the light beam was reversed from the virtual image position. By fixing the display 110 and the filter 320, and moving the lens 310 with respect to them to change the air distance, the display surface position was calculated with respect to the air distance.

With respect to diopter −3, the shift between the display surface position and the display light emitting surface position is 0.20 mm at the air distance (1.74 mm) at which the field curvature is minimized. By the display surface position being shifted from the display light emitting surface position, image blurring (that is, a reduction in resolution) occurs. Note that at the air distance (1.44 mm) at which the shift is zero (that is, no image blur occurs at the display center portion), the field curvature is 0.25 mm. With respect to diopter −5, the shift between the display surface position and the display light emitting surface position is 0.43 mm at the air distance (1.57 mm) at which the field curvature is minimized. By the display surface position being further shifted from the display light emitting surface position, image blurring further increases. Note that at the air distance (1 mm or less) at which the shift is zero (that is, no image blur occurs), the field curvature is 0.35 mm or more.

In this way, when the display 110 and the filter 320 are fixed and the lens 310 is moved with respect to them to change the air distance, the image blurring occurs by the change in relative distance between the lens 310 and the display 110, and thus it is difficult to minimize the field curvature while the image blurring is suppressed. Accordingly, it can be seen that by maintaining the relative positions of the display 110 and the lens 310 and moving the filter 320 with respect to them to change the air distance, the field curvature can be minimized while the image blurring is suppressed.

The optical apparatus 100 according to the present embodiment includes: the display 110 that outputs the image light 50 for forming the image; the optical system 300 that magnifies the image, the optical system 300 having the filter 320 (the reflective polarizing plate 321) and the lens 310 (the half mirror surface 311) that are arranged on the eye point side and the display side, respectively, on the optical axis L of the display 110, the reflective polarizing plate 321 transmitting or reflecting at least a part of the image light 50, the half mirror surface 311 being an aspherical curved surface in which the change amount of the curved surface angle continuously increases or decreases according to the distance from the center, and transmitting or reflecting at least a part of the image light 50; and the moving device 410 that moves the filter 320 (the reflective polarizing plate 321) along the optical axis L with respect to the lens 310 (the half mirror surface 311). As a result, the optical path is folded back twice between the filter 320 and the lens 310 included in the optical system 300, and the image is magnified by the lens 310 (the half mirror surface 311), so that the position of the magnified virtual image can be adjusted according to the diopter of the user.

In addition, the optical system 300 and the moving device 410 in the optical apparatus 100 according to the present embodiment are examples of a diopter optical system and a diopter adjustment mechanism that adjust the position of the magnified virtual image according to the eyesight of the user, and the optical apparatus 100 has high optical performance in a diopter adjustment range with a small size, a light size, and a small thickness by including the optical system and the mobile device.

Note that the optical apparatus 100 according to the present embodiment adopts the configuration in which the display 110, the diffractive optical element 200, and the lens 310 (the half mirror surface 311) are fixed while maintaining the relative positional relationship, and the filter 320 (the reflective polarizing plate 321) is relatively moved with respect to them by the moving device 410; however, instead of this, the optical apparatus 100 according to the present embodiment may adopt a configuration in which the relative positional relationship between the display 110, the diffractive optical element 200, and the lens 310 (the half mirror surface 311) is maintained, and the display 110, the diffractive optical element 200, and the lens 310 are relatively moved with respect to the filter 320 (the reflective polarizing plate 321) by the moving device. In such a case, for example, the holder that fixes the filter 320 to one surface of the housing on the eye point side and holds the display 110, the diffractive optical element 200, and the lens 310 (the half mirror surface 311) in an internal airtight space, may be accommodated to be able to be driven. Here, a configuration in which a hole portion is provided in the holder, or the groove portion is provided on the outer surface such that the air in the airtight space moves from one side to the other side of the holder as the holder moves, may be adopted. As a result, the sealing of the inside of the housing is maintained, and it is possible to prevent a foreign matter such as dust from infiltrating from the outside.

Note that as FIG. 9 illustrates the field curvature (the broken line), and the shift (the solid line) between the display surface position and the display light emitting surface position, with respect to the air distance for each of diopters −5 and −3, the optimum air distance at which the field curvature is minimized with respect to diopter −3 is 1.74 mm, and when the lens 310 is moved by 0.16 mm from the optimum air distance of 1.9 mm of diopter −1, the shift between the display surface position and the display light emitting surface position at that time is 0.20 mm, and thus an optimal state is obtained when the lens 310 and the display 110 maintain the relative positional relationship, and move, and are further closer by 0.04 mm. Similarly, with respect to diopter −5, the optimum air distance at which the field curvature is minimized is 1.57 mm, and when the lens 310 is moved by 0.33 mm from the optimum air distance of 1.9 mm of diopter −1, the shift between the display surface position and the display light emitting surface position at that time is 0.43 mm, and thus an optimal state is obtained when the lens 310 and the display 110 maintain the relative positional relationship, and move, and are further closer by 0.1 mm. Therefore, the optical apparatus 100 according to the present embodiment adopts the configuration in which the relative positional relationship between the display 110 and the lens 310 is maintained, and the filter 320 is driven with respect to them; however, the optical apparatus 100 according to the present embodiment may adopt a configuration in which the relative positional relationship between the display 110 and the lens 310 is changed and the filter 320 is driven with respect to them.

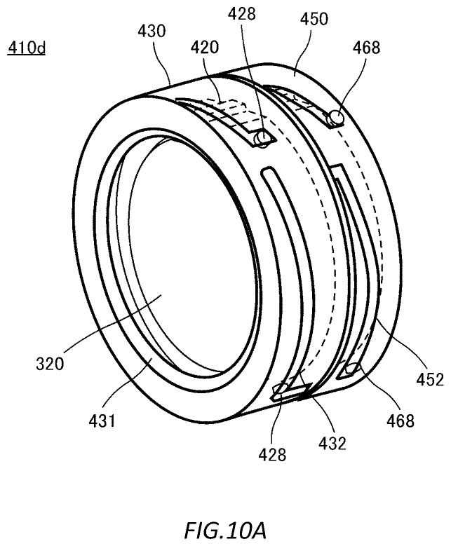

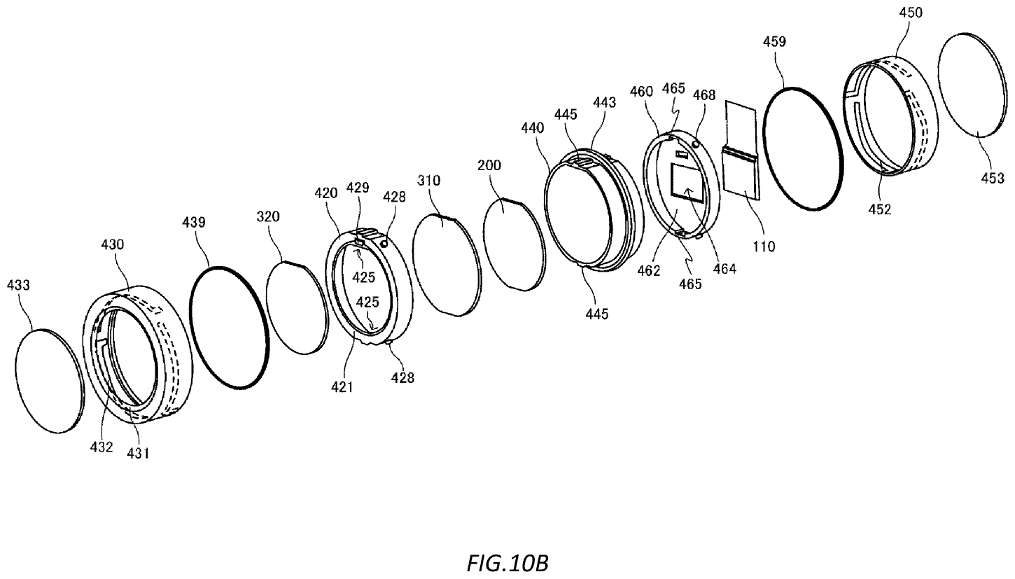

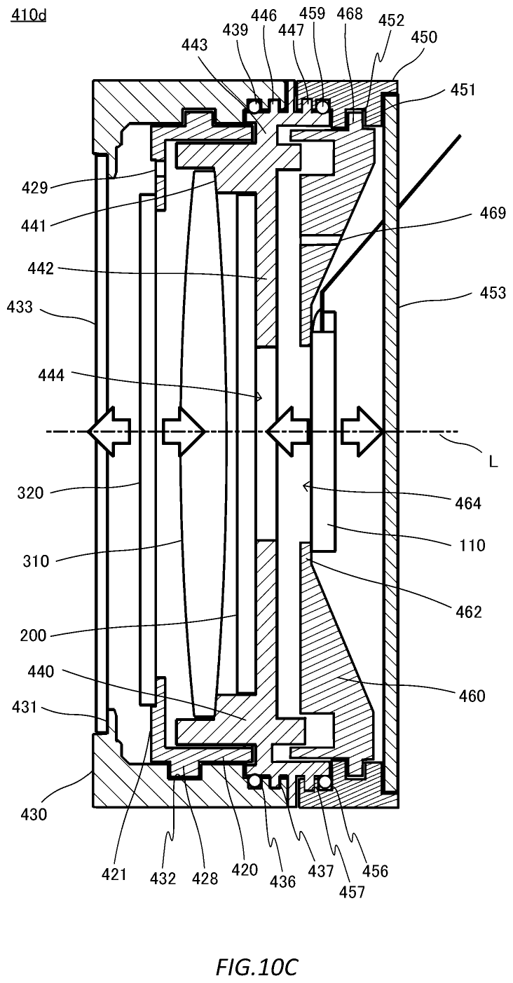

FIG. 10A, FIG. 1013, and FIG. 10C illustrate an overall configuration, an exploded configuration, and an assembled state of a moving device 410d according to a modification example, respectively. The moving device 410d includes the first holder 440, the second holder 420, the cover holder 430, a third holder 460, a cover holder 450, and seal rings 439, 459. Note that the right side of the drawing is the display side, and the left side of the drawing is the eye point side. In addition, the central axis of the moving device 410d is superimposed on the optical axis L of the optical system 300.

The first holder 440 is a fixing member that holds the diffractive optical element 200, and the lens 310 of the optical system 300. The first holder 440 is formed in a cylindrical shape having the bottom surface 442, and has the step portion 441 on the eye point side of the inner surface; the flange portion 443 formed to protrude outward at the end portion of the outer surface on the display side and extend toward the display side; protruding portions 446, 447 formed around the outer surface of the flange 443; the rectangular opening 444 formed in the center of the bottom surface 442; the two guides 445 formed to extend parallel to the optical axis L on the outer surface; and two guides (not illustrated) formed to extend parallel to the optical axis L from the outer edge of the bottom surface 442. Note that the number of guides 445 is not limited to two, and one or three or more may be formed.

The diffractive optical element 200 is fixed within the first holder 440 to be supported on the bottom surface 442. The lens 310 is fixed to the end portion of the first holder 440 on the eye point side such that the edge portion of the lens 310 is supported on the step portion 441. In this way, the diffractive optical element 200 and the lens 310 maintain their relative positional relationship in relation to the direction of the optical axis L, and are held by the first holder 440.

The second holder 420 is a movable member that holds the filter 320 of the optical system 300 and is supported to be able to be driven with respect to the first holder 440. The second holder 420 is configured similarly to that previously described.

The cover holder 430 is a movable member that holds the cover 433 and is rotated with respect to the first holder 440. The cover holder 430 is configured similarly to that previously described.

The third holder 460 is a fixing member that holds the display 110. The third holder 460 is formed in a disk shape to include a recessed portion with inclined side surfaces on the display side, and an opening 464 that is rectangular is formed in the center of a bottom surface of the recessed portion. In addition, the display 110 is fixed on the bottom surface of the recessed portion of the third holder 460 such that the display screen of the display 110 is positioned within the opening 464. Further, in the third holder 460, three cam pins 468 is formed on the outer surface to be separated from each other in the peripheral direction; a guide groove 465 that extends parallel to the optical axis L is formed on an inner surface of the recessed portion that is annular and is formed on the eye point side; and a hole portion 469 that connects the eye point side and the display side of the third holder 460, is formed.

The cover holder 450 is a movable member that holds a cover 453 and is rotated with respect to the first holder 440. The cover holder 450 is formed in a cylindrical shape having an inner diameter slightly larger than an outer diameter of the third holder 460, and has a step portion 451 formed at an end portion on the display side. The cover 453 is fitted into the cover holder 450 from the display side, and is supported on the step portion 451. Further, the cover holder 450 has three cam grooves 452 formed to extend in the direction of the optical axis L direction from the end portion on the display side, to spirally extend by changing directions, and to be separated from each other in the peripheral direction on the inner surface. In addition, the cover holder 450 has two grooves 456 and 457 formed around the display side of the inner surface.

The seal rings 439, 459 are members formed of an elastic member such as rubber in a ring shape. The seal rings 439, 459 are fitted into the grooves 436, 456 of the cover holders 430, 450 to seal an inside of the moving device 410d.

The moving device 410d is assembled as follows. First, while the guide 445 of the first holder 440 on the outer surface is put into the guide groove 425 of the second holder 420 on the inner surface, the end portion of the first holder 440 holding the lens 310 on the eye point side is inserted from the opening of the second holder 420 on the display side, into the inside thereof. Next, the seal ring 439 is fitted into the groove 436 of the cover holder 430. Then, the three cam pins 428 of the second holder 420 on the outer surface are respectively inserted into the three cam grooves 432 of the cover holder 430 on the inner surface; the end portion of the second holder 420 on the eye point side holding the filter 320 is inserted from the opening of the cover holder 430 on the display side, into the inside thereof; and further the protruding portion 446 of the first holder 440 is fitted into the groove 437 of the cover holder 430. Next, while the guide (not illustrated) of the first holder 440 on the display side is put into the guide groove 465 of the third holder 460, the end portion of the third holder 440 holding the display 110 on the eye point side is inserted into the flange 443 of the first holder 440. Then, the three cam pins 468 of the third holder 460 on the outer surface are respectively inserted into the three cam grooves 452 of the cover holder 450 on the inner surface; an end portion of the third holder 460 on the display side holding the display 110 is inserted from an opening of the cover holder 450 on the eye point side, into the inside thereof; and further the protruding portion 447 of the first holder 440 is fitted into the groove 457 of the cover holder 450. As a result, the cover holder 430 and the cover holder 450 are supported to be rotated with respect to the first holder 440, and in an internal space of the moving device 410d which is defined by the cover holder 430 holding the cover 433, the cover holder 450 holding the cover 453, and the first holder 440 holding the lens 310 or the like, the second holder 420 holding the filter 320 and the third holder 460 holding the display 110 are accommodated to be able to be driven in the direction of the optical axis L (see the arrow in FIG. 10C).

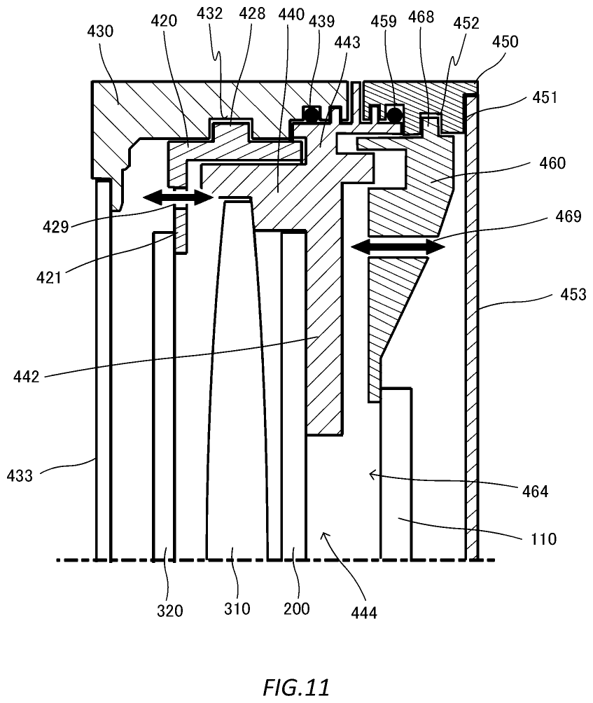

FIG. 11 illustrates an internal configuration of the moving device 410d, centering on the hole portion 429 provided in the second holder 420 and the hole portion 469 provided in the third holder 460. The seal ring 439 is interposed between the inner surface of the cover holder 430 and the outer surface of the first holder 440, and the seal ring 459 is interposed between an inner surface of the cover holder 450 and the outer surface of the first holder 440, thereby sealing the internal space of the moving device 410d. The space between the cover 433 and the filter 320 and the space between the filter 320 and the lens 310 are connected to each other by the hole portion 429 formed in the second holder 420, and as the filter 320 moves, the air moves from one space to the other space (see the arrow), and a space between the cover 453 and the display 110 and a space between the display 110 and the first holder 440 are connected to each other by the hole portion 469 formed in the third holder 460, and as the display 110 moves, the air moves from one space to the other space (see the arrow).

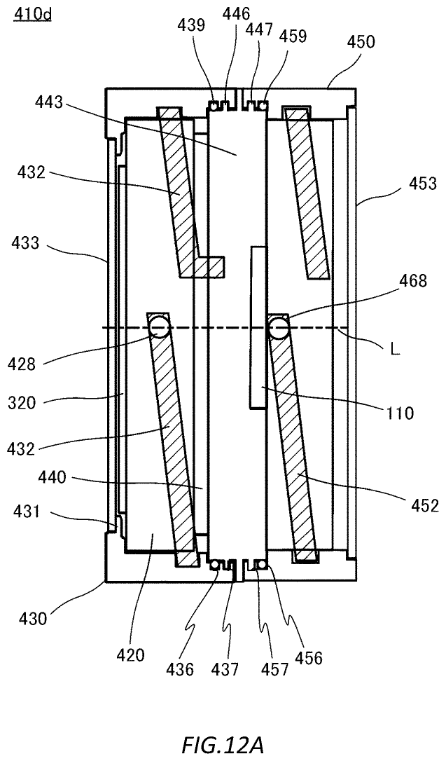

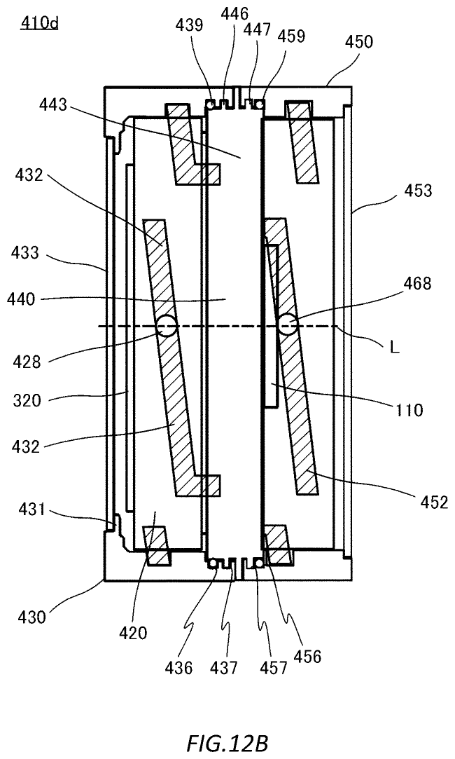

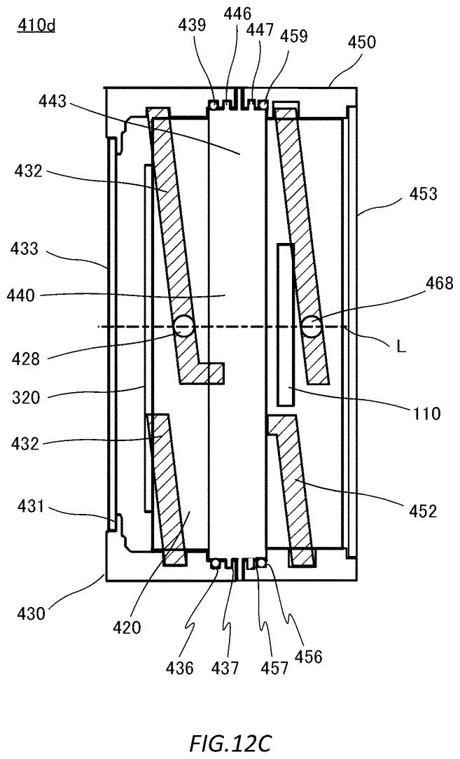

FIG. 12A, FIG. 12B, and FIG. 12C illustrate the principles of filter movements and display movements by the moving device 410d. Note that the principle of the filter movement is the same as the principle in the moving device 410, and in the moving device 410d configured as described above, when the cover holder 430 is rotated with respect to the first holder 440, the cam pin 428 formed on the outer surface of the second holder 420 is guided inside the cam groove 432 provided on the inner surface of the cover holder 430 and the guide 445 of the first holder 440 is guided inside the guide groove 425 of the second holder, whereby the second holder 420 is driven between the cover holder 430 and the first holder 440 in the direction of the optical axis L. Further, when the cover holder 450 is rotated with respect to the first holder 440, the cam pin 468 formed on an outer surface of the third holder 460 is guided inside the cam groove 452 provided on the inner surface of the cover holder 450 and the guide of the first holder 440 is guided inside the guide groove 465 of the third holder, whereby the third holder 460 is driven between the cover holder 450 and the first holder 440 in the direction of the optical axis L.

As illustrated in FIG. 12A, when the cover holder 430 is rotated clockwise when viewed from the eye point side to the display side, the cam pin 428 formed on the outer surface of the second holder 420 is guided inside the cam groove 432 provided on the inner surface of the cover holder 430 and the guide 445 of the first holder 440 is guided inside the guide groove 425 of the second holder, and the second holder 420 holding the filter 320 is unreeled to the eye point side. As a result, the filter 320 is separated from the lens 310. At this time, the internal air moves, via the hole portion 429 of the second holder 420, from the space between the cover 433 and the filter 320 to the space between the filter 320 and the lens 310 (see the rightward arrow in FIG. 11). Further, when the cover holder 450 is rotated clockwise, the cam pin 468 formed on the outer surface of the third holder 460 is guided inside the cam groove 452 provided on the inner surface of the cover holder 450 and the guide of the first holder 440 is guided inside the guide groove 465 of the third holder, and the third holder 460 holding the display 110 is retracted to the eye point side. As a result, the display 110 approaches the lens 310. At this time, the internal air moves, via the hole portion 469 of the third holder 460, from the space between the display 110 and the first holder 440 to the space between the cover 453 and the display 110 (see the rightward arrow in FIG. 11).

As illustrated in FIG. 12B and FIG. 12C, when the cover holder 430 is rotated counterclockwise, the cam pin 428 formed on the outer surface of the second holder 420 is guided inside the cam groove 432 provided on the inner surface of the cover holder 430 and the guide 445 of the first holder 440 is guided inside the guide groove 425 of the second holder, and the second holder 420 is retracted to the display side. As a result, the filter 320 approaches the lens 310. At this time, the internal air moves, via the hole portion 429 of the second holder 420, from the space between the filter 320 and the lens 310 to the space between the cover 433 and the filter 320 (see the leftward arrow in FIG. 11). Further, when the cover holder 450 is rotated counterclockwise, the cam pin 468 formed on the outer surface of the third holder 460 is guided inside the cam groove 452 provided on the inner surface of the cover holder 450 and the guide 445 of the first holder 440 is guided inside the guide groove 465 of the third holder, and the third holder 460 is unreeled to the display side. As a result, the display 110 is separated from the lens 310. At this time, the internal air moves, via the hole portion 469 of the third holder 460, from the space between the cover 453 and the display 110 to the space between the display 110 and the first holder 440 (see the leftward arrow in FIG. 11). Accordingly, the sealing of the inside of the moving device 410d is maintained, and it is possible to prevent a foreign matter such as dust from infiltrating from the outside.

Note that by independently rotating each of the cover holder 430 and the cover holder 450 with respect to the first holder 440, each of the filter 320 and the display 110 can be independently moved with respect to the lens 310. In addition, by synchronously rotating the cover holder 430 and the cover holder 450 with respect to the first holder 440, the filter 320 and the display 110 can be moved with respect to the lens 310 while their relative positions are maintained. Further, movement amounts of the filter 320 and the display 110 with respect to the rotations of the cover holder 430 and the cover holder 450 may be set on the filter 320 side and the display 110 side respectively, so that by synchronously rotating the cover holder 430 and the cover holder 450, a combination of a distance between filter 320 and lens 310 and a distance between lens 310 and display 110 is always automatically optimal for each diopter.

In this way, the moving device 410d relatively moves the filter 320 (the reflective polarizing plate 321) and the display 110 with respect to the lens 310 (the half mirror surface 311), respectively. By the cover 433 and the cover holder 430 holding the cover 433; the first holder 440 holding the lens 310; the seal ring 439 provided between the cover holder 430 and the first holder 440; the cover 453 and the cover holder 450 holding the cover 453; and the seal ring 459 provided between the cover holder 450 and the first holder 440, the inside of the moving device 410d is kept to be airtight, and the internal air moves, via the hole portion 429 of the second holder 420, between the space between the cover 433 and the filter 320 and the space between the filter 320 and the lens 310, and further, the internal air moves, via the hole portion 469 of the third holder 460, between the space between the cover 453 and the display 110 and the space between the display 110 and the first holder 440, thereby making it possible to drive the filter 320 in the space in an airtight state.

Note that the optical apparatus 100 according to the present embodiment magnifies the image light 50 of the display 110 and guides the image light to one eye 30 of the user to adjust the position of the magnified virtual image. That is, the optical apparatus 100 includes the diffractive optical element 200 and the optical system 300 only for one eye 30 of the left eye and the right eye. The binocular optical apparatus may be configured by providing the optical apparatus 100 having such a configuration, that is, the diffractive optical element 200 and the optical system 300 for each of the both eyes 30.

Note that the optical apparatus 100 according to the present embodiment has been configured to adopt an immersive virtual reality (VR) technology to magnify the image light 50 of the display 110 and guide the image light to the eye 30 of the user, but may be configured to adopt an augmented reality (AR) technology to superimpose the image light 50 of the display 110 and external light and guide the superimposed light to the eye 30 of the user.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As is clear from the above description, according to (one) embodiment of the present invention, an optical apparatus can be realized.

What is claimed is:

1. An optical apparatus that generates a magnified virtual image of an image, the optical apparatus comprising:
a display that outputs image light for forming the image;
an optical system that magnifies the image, the optical system having a first transmissive/reflective surface and a second transmissive/reflective surface that are arranged on an eye point side and a display side, respectively, on an optical axis of the optical system,
each of the first transmissive/reflective surface and the second transmissive/reflective surface transmitting or reflecting at least a part of the image light; and
a moving device that moves the first transmissive/reflective surface along the optical axis with respect to the second transmissive/reflective surface, the moving device including
a first holder that holds the display and the second transmissive/reflective surface,
a second holder that holds the first transmissive/reflective surface and is supported to be able to be driven with respect to the first holder, and
a cover that accommodates the first transmissive/reflective surface between the cover and the first holder, wherein
the second holder has a hole portion and a groove portion that communicate with a space between the cover and the first transmissive/reflective surface and a space between the first transmissive/reflective surface and the second transmissive/reflective surface, and/or a gap with the cover.

2. The optical apparatus according to claim 1, wherein the cover has a seal member that is provided between the cover and the first holder.

3. The optical apparatus according to claim 1, wherein the first transmissive/reflective surface reflects at least a part of the image light transmitted through the second transmissive/reflective surface, and transmits at least a part of the image light reflected on the second transmissive/reflective surface.

4. The optical apparatus according to claim 2, wherein the first transmissive/reflective surface reflects at least a part of the image light transmitted through the second transmissive/reflective surface, and transmits at least a part of the image light reflected on the second transmissive/reflective surface.

5. The optical apparatus according to claim 3, wherein the first transmissive/reflective surface is a polarizing element that reflects one of linearly polarized lights orthogonal to each other and transmits the other.

6. The optical apparatus according to claim 1, wherein the second transmissive/reflective surface transmits at least a part of the image light which is sent from the display, and reflects a part of the image light which is reflected on the first transmissive/reflective surface and is returned.

7. The optical apparatus according to claim 2, wherein the second transmissive/reflective surface transmits at least a part of the image light which is sent from the display, and reflects a part of the image light which is reflected on the first transmissive/reflective surface and is returned.

8. The optical apparatus according to claim 3, wherein the second transmissive/reflective surface transmits at least a part of the image light which is sent from the display, and reflects a part of the image light which is reflected on the first transmissive/reflective surface and is returned.

9. The optical apparatus according to claim 6, wherein the second transmissive/reflective surface is a half mirror surface.

10. The optical apparatus according to claim 1, wherein
the optical system further has a lens element, and
the second transmissive/reflective surface is provided on one surface of the lens element on the display side.

11. The optical apparatus according to claim 2, wherein
the optical system further has a lens element, and
the second transmissive/reflective surface is provided on one surface of the lens element on the display side.

12. The optical apparatus according to claim 1, wherein the second transmissive/reflective surface is an aspherical curved surface in which a change amount of a curved surface angle continuously increases or decreases according to a distance from a center.

13. The optical apparatus according to claim 12, wherein the change amount of the curved surface angle of the second transmissive/reflective surface continuously decreases from 1.1 degrees to 0.4 degrees from the center to an outer edge.

14. The optical apparatus according to claim 1, wherein the first holder maintains a relative positional relationship between the display and the second transmissive/reflective surface.

15. The optical apparatus according to claim 1, wherein the moving device further moves the display along the optical axis with respect to the second transmissive/reflective surface, and the first holder has two sub-holders that respectively hold the display and the second transmissive/reflective surface and approach each other and are separated from each other.

16. An optical apparatus that generates a magnified virtual image of an image, the optical apparatus comprising:
a display that outputs image light for forming the image;
an optical system that magnifies the image, the optical system having a first transmissive/reflective surface and a second transmissive/reflective surface that are arranged on an eye point side and a display side, respectively, on an optical axis of the optical system,
the first transmissive/reflective surface transmitting or reflecting at least a part of the image light,
the second transmissive/reflective surface being an aspherical curved surface in which a change amount of a curved surface angle continuously increases or decreases according to a distance from a center, and transmitting or reflecting at least a part of the image light; and
a moving device that moves the first transmissive/reflective surface along the optical axis with respect to the second transmissive/reflective surface.

17. The optical apparatus according to claim 16, wherein the moving device maintains a relative positional relationship between the display and the second transmissive/reflective surface, and moves the first transmissive/reflective surface.

18. The optical apparatus according to claim 16, wherein the first transmissive/reflective surface is a polarizing element that reflects one of linearly polarized lights orthogonal to each other and transmits the other.

19. The optical apparatus according to claim 16, wherein the second transmissive/reflective surface is a half mirror surface.

20. The optical apparatus according to claim 16, wherein
the optical system further has a lens element, and
the second transmissive/reflective surface is provided on one surface of the lens element on the display side.
